(19) United States
(12) Patent Application Publication
(10) Pub. No.: US 2008/0143646 A1
(43) Pub. Date: Jun. 19, 2008

(54) Apparatus and method for driving a plasma display panel

(76) Inventor: Byung-gwon Cho, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/000,705

(22) Filed: Dec. 17, 2007

(30) Foreign Application Priority Data
Dec. 15, 2006 (KR) 10-2006-0128677

(51) Int. Cl. G09G 3/28

(52) U.S. Cl. 345/60

(57) ABSTRACT

A plasma display apparatus may include a PDP having respective pluralities of first electrodes formed in a first direction, and second and third electrodes formed in a second direction perpendicular to the first direction, and a driving apparatus to alternately apply first and second sustain discharge pulses to one of the second electrodes and the third electrodes, the first sustain discharge pulses having a second voltage higher than a first voltage as a peak value and having a first pulse width, and the second sustain discharge pulses having a third voltage lower than the first voltage as a peak value and having a second pulse width shorter than the first pulse width.

### BACKGROUND OF THE INVENTION

1. Field of the Invention

Embodiments relate to an apparatus and a method for driving a plasma display panel.

2. Description of the Related Art

A plasma display panel (“PDP”) is a flat panel display for displaying letters or images using plasma generated by gas discharge. The PDP can have several tens to at least several millions of pixels arranged in a matrix, depending on the size of the PDP. Scan electrodes and sustain electrodes are formed parallel with one another, and address electrodes are formed in a direction perpendicular to the scan electrodes and the sustain electrodes on a side of a substrate in the PDP. The sustain electrodes are formed to correspond to the scan electrodes, respectively, and ends of the sustain electrodes can be connected to each other.

According to a conventional method for driving a PDP, an externally-provided image signal is divided into frames, each frame is divided into subfields, and then the PDP is driven using the subfields. Each of the subfields includes a reset period, an address period, and a sustain period. The reset period is a period for resetting each of cells so as to easily perform an addressing operation in the cells. The address period is a period for determining whether the cells are turned on or off in the PDP to perform an operation of storing a wall charge in the turned-on cells. The sustain period is a period for performing an electric discharge to actually display an image in the cells to be turned on. During the sustain period, sustain discharge pulses are alternately applied to a scan electrode and a sustain electrode. A reset waveform and a scan waveform are applied to the scan electrode during the reset period and the address period. Another conventional sustain driving method applies a sustain discharge pulse to either the scan electrode or the sustain electrode, instead of alternately applying the sustain discharge pulses to the scan electrode and the sustain electrode.

Whether applied to the scan electrode or the sustain electrode, the sustain discharge waveform alternate from a positive pulse having a voltage +Vs as a peak value to a negative pulse having a voltage −Vs as a peak value, with the pulse width of the positive pulse being the same as the pulse width of the negative pulse. If the −Vs voltage is applied to a scan electrode, then a facing discharge can be caused in addition to a surface discharge, i.e., a dual discharge phenomenon can occur in a cell. A dual discharge phenomenon results in an asymmetrical optical waveform being applied to the cell. The asymmetrical optical waveform causes a problem, namely that the positive sustain discharge pulses achieve electric discharges that are relatively weaker than electric discharges which the negative sustain discharge pulses can achieve. Such imbalanced electric discharges can cause the discharge of the cell to be unstable.

### SUMMARY OF THE INVENTION

Embodiments of the present invention are therefore directed to methods and apparatuses for driving a PDP, which respectively substantially overcome one or more of the problems of the related art.

It is therefore a feature of an embodiment of the present invention to provide methods and apparatuses for driving a PDP by which a problem of applying an asymmetric optical waveform to the PDP may be compensated, e.g., by using sustain discharge pulses of different pulse widths, e.g., first and second discharge pulses. For example, the first and second sustain discharge pulses may have the same absolute value and opposite polarities, and the first sustain discharge pulse may have a wider/longer pulse width than that of the second sustain discharge pulse.

At least one of the above and other features and advantages of embodiments may be realized by providing a method for driving a PDP including respective pluralities of first electrodes formed in a first direction, and second and third electrodes formed in a second direction perpendicular to the first direction. Such a method may include selectively applying selection pulses to the first electrodes and the second electrodes, respectively, to select cells of the plasma display device for electrical discharge, and alternately applying first and second sustain discharge pulses to one of the second and third electrodes, the first sustain discharge pulses having a second voltage higher than a first voltage as a peak value and having a first pulse width, and the second sustain discharge pulses having a third voltage lower than the first voltage as a peak value and having a second pulse width, wherein the first pulse width is longer than the second pulse width.

The second voltage and the third voltage may have substantially the same absolute value relative to the first voltage.

The alternately applying first and second sustain discharge pulses, mentioned above, may include applying, to the electrodes receiving the first and second sustain discharge pulses, a first initial discharge pulse having a third pulse width longer than the first pulse width of the first sustain discharge pulse and having the second voltage as a peak value; and applying, to the electrodes receiving the first and second sustain discharge pulses, a second initial discharge pulse having a fourth pulse width longer than the first pulse width of the first sustain discharge pulse and having the third voltage as a peak value. In a first circumstance, the first and second sustain discharge pulses may be applied to the second electrodes; and the second initial discharge pulse may follow the first initial discharge pulse. In a second circumstance, the first and second sustain discharge pulses may be applied to the third electrodes, and the second initial discharge pulse may precede the first initial discharge pulse.

Such a method as mentioned above may further include resetting voltages on the third electrodes before selectively applying selection pulses. The third electrode may be biased to a fourth voltage during selectively applying selection pulses

At least one of the above and other features and advantages of the present invention may be realized by providing a plasma display apparatus. Such a plasma display apparatus may include a plasma display panel (“PDP”) including respective pluralities of first electrodes formed in a first direction, and second and third electrodes formed in a second direction perpendicular to the first direction, and a driving apparatus to alternately apply first and second sustain discharge pulses to one of the second electrodes and the third electrodes, the first sustain discharge pulses having a second voltage higher than a first voltage as a peak value and having a first pulse width, and the second sustain discharge pulses having a third voltage lower than the first voltage as a peak value and having a second pulse width; wherein the first pulse width may be longer than the second pulse width.

### BRIEF DESCRIPTION OF THE DRAWINGS

The above and other features and advantages of the embodiments will become more apparent to those of ordinary skill in the art by describing in detail exemplary embodiments thereof with reference to the attached drawings, in which:

FIG. 1 illustrates a perspective view of a PDP driven according to an AC-type 3 electrode surface discharge process according to an exemplary embodiment of the present invention;

FIG. 2 illustrates a block diagram of an apparatus for driving a PDP according to an exemplary embodiment of the present invention;

FIG. 3 illustrates waveforms for driving a plasma display apparatus according to another exemplary embodiment of the present invention; and

FIG. 4 illustrates waveforms for driving a plasma display apparatus according to another exemplary embodiment of the present invention.

### DETAILED DESCRIPTION OF THE INVENTION

Korean Patent Application No. 10-2006-0128677, filed on Dec. 15, 2006, in the Korean Intellectual Property Office, and entitled: “Apparatus and Method for Driving for Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the exemplary embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

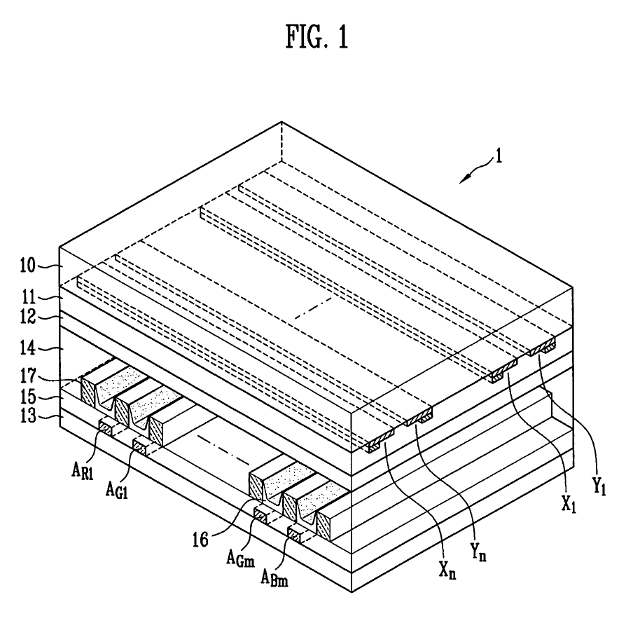

Referring to FIG. 1, a PDP 1 may include address electrode lines (AR1, AG1, . . . AGm, ABm), dielectric layers 11, 15, scan electrodes (Y1, . . . Yn), sustain (common) electrodes (X1, . . . Xn) and a protective layer 12, e.g., a magnesium oxide (MgO) layer, between front and rear glass substrates 10, 13. The scan electrodes (Y1, . . . Yn) and sustain electrodes (X1, . . . Xn) may be formed on an inner surface of the front glass substrate 10, and may be oriented in a first direction. The address electrodes (AR1, AG1, . . . AGm, ABm) may be formed on an inner surface of the rear glass substrate 13, and may be in a second direction perpendicular to the first direction. A barrier rib 17 for dividing the address electrode lines may be installed between front and rear glass substrates 10, 13 of the PDP 1, and a fluorescent material 16 for emitting R, G, B visible rays in every line may be provided on the barrier rib 17.

In a driving method applicable to the PDP 1, a reset period, an address period, and a sustain period may be continuously carried out in a unit subfield. All charges of display cells may be made uniform during the reset period. A wall voltage may be generated in the selected display cells during the address period. The display cells forming the wall voltage during the address period may cause a sustain discharge during the sustain period by applying an AC voltage to all the XY electrode line pairs. Plasma may be formed in an electric discharge space 14, namely a gas layer of the selected display cells for causing a sustain discharge during the sustain period, and then a fluorescent layer may be excited by UV irradiation to generate the light.

In the discussion that follows, various voltages are mentioned. The voltages include those listed in the following table:

| | |
|---|---|
| Vset | a voltage that may be of a magnitude sufficient to cause |
| | an electric discharge in cells under all conditions; |
| Vnf | a voltage that may approximate a magnitude sufficient |
| | to cause an electric discharge between the Y electrode |
| | and the X electrode; |
| Va | an addressing voltage; |
| +Vs | a positive voltage that may represent a peak value of a |
| | first sustain discharge pulse; |
| −Vs | a negative voltage that may represent a peak value of a |
| | second sustain discharge pulse; |
| Vwxy | a wall voltage that may be induced by the Y electrode |
| | and the X electrode; |
| Vfxy | a discharge firing voltage that may be induced between |
| | the Y electrode and the X electrode; |
| VscH | a relatively higher scan voltage; and |
| VscL | a relatively lower scan voltage. |

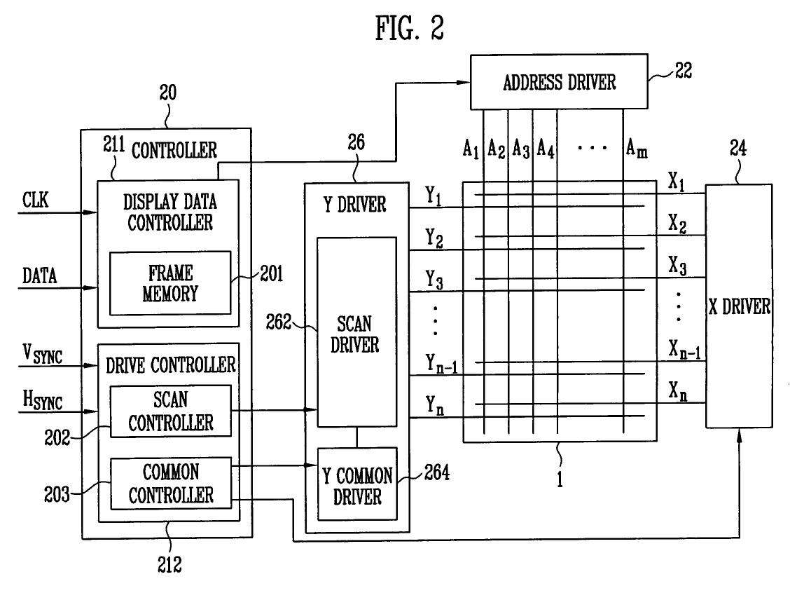

FIG. 2 illustrates a block view of an apparatus for driving PDP 1, e.g., the PDP 1 of FIG. 1, according to an exemplary embodiment of the present invention. The driving apparatus of FIG. 2 may drive a PDP including a plurality of scan electrodes, a plurality of sustain electrodes and a plurality of address electrode formed in a direction in which the address electrodes may be crossed with the scan electrodes and the sustain electrodes. The driving apparatus may include: a Y driver 26 for driving a plurality of the scan electrodes; an X driver 24 for driving a plurality of the sustain electrodes; and an address driver 22 for driving a plurality of the address electrodes. Each of the drivers may be responsive to a controller 20 for generating and transmitting scan signals, sustain discharge signal, and address signals, respectively. The Y driver 26 may include a scan driver 262 and a Y common driver 264.

The controller 20 may include a display data controller 211 and a drive controller 212. The display data controller 211 may include an internal frame memory 201, and the drive controller 212 may include a scan controller 202 and a common controller 203. The controller 20 may receive a clock signal (CLK), a data signal (DATA), a vertical synchronizing signal (V_{SYNC}) and a horizontal synchronizing signal (H_{SYNC}) from sources external to the controller 20.

The display data controller 211 may store the data signal (DATA) in the internal frame memory 201 according to the clock signal (CLK), and then may input a corresponding address control signal to the address driver 22.

The address driver 22 may process an address control signal from the display data controller 211 to apply corresponding display data signals to the address electrode lines (A1, . . . Am) of the PDP 1 during an address period. Here, the reference A1 can be corresponded to AR1, AG1 and AB1 (not shown) in FIG. 1. The drive controller 212 may process the vertical synchronizing signal (V_{SYNC}) and the horizontal synchronizing signal (H_{SYNC}). The scan controller 202 may generate signals controlling the scan driver 262, and the common controller 203 may generate signals controlling the Y common driver 264 and the X driver 24. The scan driver 262 of the Y driver 26 may apply a corresponding scan drive signal to each of the scan electrode lines (Y1, . . . Yn) during the address period according to a control signal from the scan controller 202. The Y common driver 264 of the Y driver 26 may simultaneously apply a common drive signal to the Y electrode lines (Y1, . . . Yn) during a sustain discharge period according to a control signal from the common controller 212. The X driver 24 may simultaneously apply a common drive signal to the X electrode lines (X1, . . . Xn) during a sustain discharge period according to a control signal from the common controller 203.

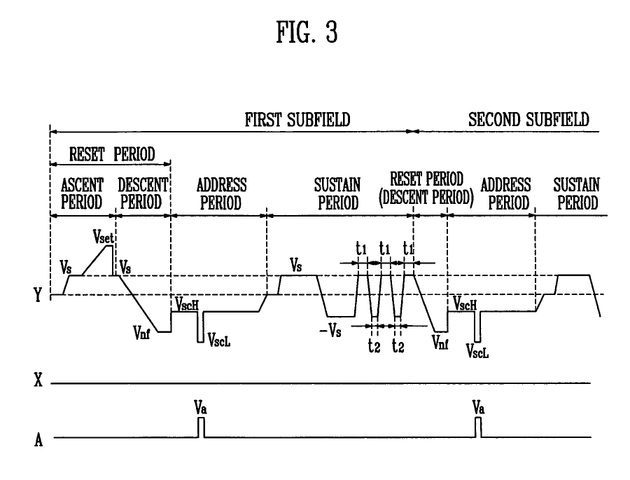

FIG. 3 illustrates a driving waveform view of a PDP according to another exemplary embodiment of the present invention. Hereinafter, for the sake of simplicity, driving waveforms that may be applied to a scan electrode (Y electrode), a sustain electrode (X electrode) and an address electrode (A electrode) which define only one cell of the PDP, respectively, will be described in detail. Also for simplicity, only two subfields among a plurality of the subfields are shown herein, and the subfields are referred to as a first subfield and a second subfield. The first subfield may include a reset period, an address period and a sustain period. The reset period itself may include an ascent period and a descent period.

During the ascent period within the reset period, a voltage of the Y electrode may be gradually increased to a Vset voltage while maintaining an A electrode and an X electrode at a standard voltage, e.g., a ground voltage. The Vset voltage may be greater than a +Vs voltage, discussed below. An insignificant electric discharge (hereinafter, referred to as a “weak electric discharge”) may be induced between the Y electrode and the X electrode, and between the Y electrode and the A electrode during a period when the voltage of the Y electrode is increased. At this time, a (−) wall charge may be formed proximate to the Y electrode, and a (+) wall charge may be formed proximate to the X and A electrodes. If a voltage of an electrode is gradually changed, a weak electric discharge may be induced in cells, and then a wall charge may be formed so that the sum of a voltage applied from the outside and a wall voltage of the cells can maintain a discharge firing voltage.

Also regarding the ascent period, the Vset voltage may be made sufficiently large so as to cause an electric discharge in cells under all conditions since all the cells are reset during the reset period. The voltage on the Y electrode may be decreased from the Vset voltage to the +Vs voltage by such a discharge. The +Vs voltage may generally be a voltage such as a voltage applied to the Y electrode during a sustain period, and may be lower than a discharge firing voltage between the Y electrode and the X electrode.

During the descent period within the reset period, a voltage of the Y electrode may be gradually decreased from a +Vs voltage to a Vnf voltage while, e.g., maintaining an A electrode at a standard voltage. Generally, the size of the Vnf voltage may be set at approximately a discharge firing voltage between the Y electrode and the X electrode. A weak electric discharge may be made to occur between the Y electrode and the X electrode, and between the Y electrode and the A electrode during a period when the voltage of the Y electrode is decreased. At this time, a (−) wall charge may be formed proximate to the Y electrode, and a (+) wall charge may be formed proximate to the X electrode, and the A electrode may be erased.

Also during the descent period, a wall voltage between the Y electrode and the X electrode may be made to approach about 0V, and therefore the likelihood of an erroneous discharge may be reduced, if not prevented, in cells in which an address discharge is not generated during the address period. A wall voltage between the Y electrode and the A electrode may be determined according to the level of the Vnf voltage since the A electrode, e.g., is maintained to a standard voltage.

Initially during the address period, the Y electrodes may be biased to a VscH voltage. Then, a scan pulse (VscL), that may be lower than the VscH voltage, and an address pulse (Va) may be applied to the Y electrode and the A electrode, respectively, to select certain cells that may cause an electric discharge during the address period. A not-selected Y electrode may remain biased to the VscH voltage higher than the VscL voltage, and a standard voltage may be applied to the A electrode of the cells not desired to be turned on. For this operation, Y electrodes to which a scan pulse of the VscL will be applied may be selected among the Y electrodes (Y1˜Yn), and A electrodes to which an address pulse will be applied may be selected among the A electrodes (A1˜Am), in effect, to select cells of the panel located at intersections of selected Y electrodes and selected A electrodes. Such selected cells may form a (+) wall charge proximate to the Y electrode and a (−) wall charge proximate to the A and X electrodes due to the address discharge.

Regarding the sustain period, a procedure of applying alternating sustain discharge pulses of different pulse widths may be performed. The procedure includes applying a first sustain discharge pulse and a second sustain discharge pulse. For example, the first sustain discharge pulse may have a positive voltage Vs (+Vs) as a peak value and a pulse width t1, and the second sustain discharge pulse may have a negative voltage Vs (−Vs) as a peak value and a pulse width t2, where t2<t1. If no biasing voltage is applied to the Y-electrode, then the voltages +Vs and −Vs of the first and second sustain discharge pulses, respectively, may be described as being positive and negative, respectively, relative to a ground voltage. The procedure may be repeated. The total number of procedures that are to be performed during a given subfield may vary according to the weight value assigned to the given subfield, where the weight value may represent a relative brightness of the given subfield amongst other subfields.

In the case of the cells in which an address discharge was caused, the procedure may take place as follows. During the address period, a wall voltage (Vwxy) induced by the Y electrode and the X electrode may be increased to a high level, and then the first sustain discharge pulse having the +Vs voltage may be applied firstly to the Y electrode to cause a first sustain discharge between the Y electrode and the X electrode. At this time, the +Vs voltage may be set to a lower level than a discharge firing voltage (Vfxy) between the Y electrode and the X electrode, and a (Vs+Vwxy) voltage may be set to a higher level than the Vfxy voltage. As a result of the first sustain discharge, a (−) wall charge may be formed proximate to the Y electrode, and a (+) wall charge may be formed proximate to the X electrode and the A electrode, and therefore a wall voltage (Vfyx) induced by the X electrode and the Y electrode may be increased to a high level.

Later in the sustain period, after the wall voltage (Vfyx) is increased to a high level, the second sustain discharge pulse having the negative voltage −Vs may be applied to the Y electrode to cause a second sustain discharge between the Y electrode and the X electrode. As a result, a (+) wall charge may be formed proximate to the Y electrode, and a (−) wall charge may be formed proximate to the X electrode and the A electrode. Therefore, sustain discharges may be caused when the +Vs and −Vs voltages are alternatively applied, respectively, to the Y electrode. Subsequently in the sustain period, the procedure of applying alternating sustain discharge pulses may be repeated.

As the procedure of applying alternating sustain discharge pulses is carried out, a dual discharge phenomenon may occur. During a dual discharge, two discharges occur concurrently, e.g., a surface discharge between the X electrode and the Y electrode may occur and a point-to-point discharge between the Y electrode and the A electrode may occur. If the dual discharge phenomenon occurs while using the same pulse widths for the first and second the sustain discharge pulses, then a problem of an asymmetric optical waveform can result. The asymmetrical optical waveform causes the problem that the positive sustain discharge pulses achieve electric discharges that are relatively weaker than electric discharges which the negative sustain discharge pulses can achieve. Using different pulse widths for the first and second sustain discharge pulses can compensate for the asymmetrical waveform resulting from the dual discharge phenomenon. Accordingly, the pulse width t1 of the first sustain discharge pulse may be made greater/longer than the pulse width t2 of the second sustain discharge pulse, i.e., t1>t2.

To restate, resetting the voltages on the X electrodes, and after applying selection pulses to the Y electrodes and the A electrodes, respectively, to select cells of the plasma display device for electrical discharge, the procedure of applying alternating first and second sustain discharge pulses to the Y electrodes may be performed. The first sustain discharge pulses may have a second voltage, e.g., +Vs, higher than a first voltage (e.g., a ground voltage) as a peak value and have a first pulse width, e.g., t1. The second sustain discharge pulses may have a third voltage, e.g., −Vs, lower than the first voltage, e.g., V4=+Vs−Vs, as a peak value and have a second pulse width, t2, where t2<t1.

To promote stability of the electric discharge, first and second initial discharge pulses may be applied to the Y electrode. The first initial discharge pulse may have a longer pulse width than that of the first sustain discharge pulse, and may have the positive voltage +Vs as a peak value. The second initial discharge pulse may have a pulse width longer than that of the first sustain discharge pulse but shorter pulse width than that of the first initial discharge pulse, and may have the negative voltage −Vs as a peak value.

In order to apply the sustain discharge pulses as described above, the controller 20 of the driving apparatus may apply a driving waveform that sets the pulse width of the first sustain discharge pulses to be greater/longer than that of the second sustain discharge pulses. Furthermore, the controller 20 may set a peak value of the first sustain discharge pulses to have a positive voltage (e.g., +Vs), and a peak value of the second sustain discharge pulses to have a negative voltage (e.g., −Vs).

A second subfield may follow the first subfield. In the second subfield, the reset period may include only a descent period. During such a descent period, a voltage of the Y electrode may be gradually decreased to a Vnf voltage. At the start of the descent period in the second subfield, the voltage on the Y electrode may be either the +Vs voltage or the −Vs voltage depending upon whether the last sustain discharge pulse in the preceding first subfield was a first sustain discharge pulse or a second sustain discharge pulse, respectively. During the descent period of the second subfield, a (−) wall charge can be formed proximate to the Y electrode and a (+) wall charge can be formed proximate to the X electrode and the A electrode. As in the descent period of the reset period in the first subfield, a weak electric discharge can be caused during the descent period of the reset period of the second subfield if a voltage of the Y electrode exceeds a discharge firing voltage along with the wall voltage formed in the cells while the voltage of the Y electrode is decreased gradually.

An address discharge may be avoided during the address period of the second subfield if a sustain discharge was not caused during the sustain period of the first subfield. In such circumstances, the wall charge state of the cells is maintained intact after the descent period of the first subfield is completed. A wall voltage, formed after the descent period of the first subfield is completed, may have a value approximating a sum of the discharge firing voltage together with an applied voltage, and therefore an electric discharge may be avoided if a voltage of the Y electrode decreased to a Vnf voltage. Accordingly, the wall charge state set during the reset period of the first subfield may be maintained intact since an electric discharge may be avoided during the reset period of the second subfield.

After the reset period in the second subfield, i.e., for the address and sustain periods of the second subfield, the driving waveform may be substantially similar to the address and sustain periods of the first subfield. Accordingly, minimal description of the driving waveform during the address and sustain periods of the second subfield is provided, for the sake of brevity. A difference of note is that the number of times to perform the procedure of applying alternating first and second sustain discharge pulses during the second subfield may differ from the number of times the procedure is performed during the first subfield.

As described above, a reset operation, an address operation, and a sustain discharge operation may be carried out using a driving waveform applied to the Y electrode while biasing the X electrode to a standard voltage, according to an exemplary embodiment of the present invention. Alternatively, e.g., sustain discharge pulses may be alternately applied to the X electrode.

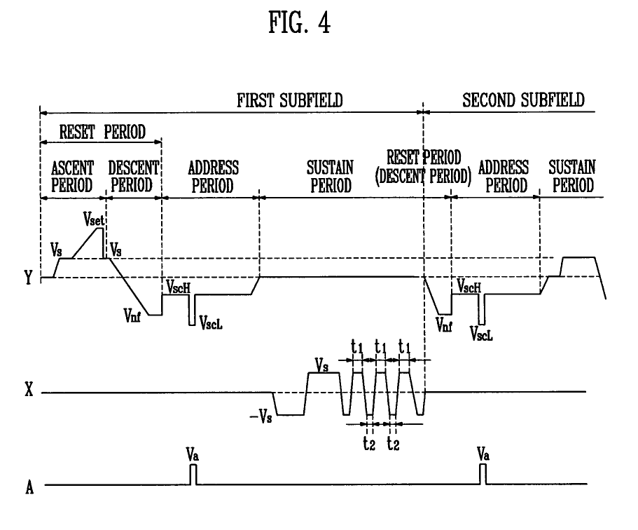

FIG. 4 is substantially similar to the above-mentioned FIG. 3 in the aspect of the entire configuration, except, e.g., that the procedure of applying alternating sustain discharge pulses may be performed relative to the X electrode rather than to the Y electrode. For the sake of brevity, the following discussion will focus upon differences between FIG. 4 and FIG. 3.

As illustrated in FIG. 4, during the sustain period, a preparatory pulse having a −Vs voltage may be first applied to the X electrode to cause a preparatory sustain discharge between the Y electrode and the X electrode. In view of there being a (+) wall charge that had been formed proximate to the Y electrode and a (−) wall charge that had been formed proximate to the A and X electrodes due to the address discharge, application of the preparatory pulse causes the preparatory discharge, which may cause a wall voltage (Vwxy) of the Y electrode relative to the X electrode to be increased to a high level. As a result of the preparatory sustain discharge, a (−) wall charge can be formed proximate to the Y electrode, and a (+) wall charge can be formed proximate to the X electrode and the A electrode. Therefore, a wall voltage (Vfyx) of the X electrode relative to the Y electrode can be increased to a high level.

Later in the sustain period illustrated in FIG. 4, the procedure of applying alternating sustain discharge pulses may be applied to the X electrode. The procedure may begin by applying a first sustain discharge pulse having the positive voltage +Vs and the pulse width t1 to the X electrode to cause a first sustain discharge between the Y electrode and the X electrode since a ratio of the wall voltage (Vfyx) of the X electrode to the Y electrode is increased to a high level. As a result of first sustain discharge, a (+) wall charge can be formed proximate to the Y electrode, and a (−) wall charge can be formed proximate to the X electrode and the A electrode. Next, a second sustain discharge pulse having the negative voltage −Vs and the pulse width t2, t2<t1, may be applied to the X electrode, thereby causing a second sustain discharge The number of times that the procedure is performed during a given subfield may vary according to the weight value assigned to the given subfield.

To promote stability of the electric discharge, first and second initial discharge pulses also may be applied to the X electrode. As illustrated in FIG. 4, the second initial discharge pulse has a pulse width longer than that of the first initial discharge pulse.

According to one or more embodiments of the present invention, the above-described problem of an asymmetric optical waveform may be compensated by using sustain discharge pulses of different pulse widths, e.g., first and second discharge pulses. For example, the first and second sustain discharge pulses may have equal absolute values and opposite polarities, and the first sustain discharge pulse may have a wider pulse width than that of the second sustain discharge pulse.

Exemplary embodiments of the present invention have been disclosed herein, and although specific terms are employed, they are used and are to be appreciated interpreted in a generic and descriptive sense only and not for purpose of limitation. Accordingly, it will be understood by those of ordinary skill in the art that various changes in form and details may be made without departing from the spirit and scope of the present invention, as set forth in the following claims.

What is claimed is:

1. A method for driving a plasma display panel (“PDP”) including respective pluralities of first electrodes formed in a first direction, and second and third electrodes formed in a second direction perpendicular to the first direction, the method comprising:
selectively applying selection pulses to the first electrodes and the second electrodes, respectively, to select cells of the plasma display device for electrical discharge; and
alternately applying first and second sustain discharge pulses to one of the second and third electrodes, the first sustain discharge pulses having a second voltage higher than a first voltage as a peak value and having a first pulse width, and the second sustain discharge pulses having a third voltage lower than the first voltage as a peak value and having a second pulse width;
wherein the first pulse width is longer than the second pulse width.

2. The method for driving a PDP as claimed in claim 1, wherein the first voltage is a ground voltage.

3. The method for driving a PDP as claimed in claim 1, wherein the second voltage and the third voltage have substantially the same absolute value relative to the first voltage.

4. The method for driving a PDP as claimed in claim 1, wherein the alternately applying first and second sustain discharge pulses includes:
applying, to the electrodes receiving the first and second sustain discharge pulses, a first initial discharge pulse having a third pulse width longer than the first pulse width of the first sustain discharge pulse and having the second voltage as a peak value; and
applying, to the electrodes receiving the first and second sustain discharge pulses, a second initial discharge pulse having a fourth pulse width longer than the first pulse width of the first sustain discharge pulse and having the third voltage as a peak value.

5. The method for driving a PDP as claimed in claim 4, wherein:
the first and second sustain discharge pulses are applied to the second electrodes; and
the second initial discharge pulse follows the first initial discharge pulse.

6. The method for driving a PDP as claimed in claim 4, wherein:
the first and second sustain discharge pulses are applied to the third electrodes; and
the second initial discharge pulse precedes the first initial discharge pulse.

7. The method for driving a PDP as claimed in claim 1, further comprising, during selectively applying selection pulses, biasing the third electrodes to a fourth voltage.

8. The method for driving a PDP as claimed in claim 1, further comprising, during applying the first and second sustain discharge pulses, biasing the one of the second and third electrodes not receiving the first and second sustain discharge to a fourth voltage.

9. The method for driving a PDP as claimed in claim 8, wherein the fourth voltage is a ground voltage.

10. The method for driving a PDP as claimed in claim 1, further comprising, before selectively applying selection pulses, resetting voltages on the third electrodes.

11. A plasma display apparatus, comprising:
a plasma display panel (“PDP”) including respective pluralities of first electrodes formed in a first direction, and second and third electrodes formed in a second direction perpendicular to the first direction; and
a driving apparatus to alternately apply first and second sustain discharge pulses to one of the second electrodes and the third electrodes, the first sustain discharge pulses having a second voltage higher than a first voltage as a peak value and having a first pulse width, and the second sustain discharge pulses having a third voltage lower than the first voltage as a peak value and having a second pulse width;
wherein the first pulse width is longer than the second pulse width.

12. The plasma display apparatus according to claim 11, wherein the second voltage and the third voltage have substantially the same absolute value relative to the first voltage.

13. The plasma display apparatus as claimed in claim 11, wherein the driving apparatus is further operable to bias the one of the second and third electrodes not receiving the first and second sustain discharge to a fourth voltage during a period when the first and second sustain discharge pulses are applied to the second electrodes.

14. The plasma display apparatus as claimed in claim 11, wherein the driving apparatus is further operable to:
apply, to the electrodes receiving the first and second sustain discharge pulses, a first initial discharge pulse having a third pulse width longer than the first pulse width of the first sustain discharge pulse and having the second voltage as a peak value; and
apply, to the electrodes receiving the first and second sustain discharge pulses, a second initial discharge pulse having a fourth pulse width longer than the first pulse width of the first sustain discharge pulse and having the third voltage as a peak value.

15. The plasma display apparatus as claimed in claim 14, wherein:
the first and second sustain discharge pulses are applied to the second electrodes; and
the second initial discharge pulse follows the first initial discharge pulse.

16. The plasma display apparatus as claimed in claim 14, wherein:
the first and second sustain discharge pulses are applied to the third electrodes; and
the second initial discharge pulse precedes the first initial discharge pulse.

17. The plasma display apparatus as claimed in claim 14, wherein the fourth pulse width is shorter than the third pulse width.

18. The plasma display apparatus as claimed in claim 11, wherein the driving apparatus is further operable to selectively applying selection pulses to the first and second electrodes.

19. The plasma display apparatus as claimed in claim 18, wherein the driving apparatus is further operable, while selectively applying selection pulses, biasing the third electrodes to a fourth voltage.

20. The plasma display apparatus according to claim 18, wherein the driving apparatus is further operable to reset voltages on the third electrodes before selectively applying selection pulses.
